(19) United States
(12) Patent Application Publication
(10) Pub. No.: US 2020/0087113 A1
(43) Pub. Date: Mar. 19, 2020

(54) ARRANGEMENT AND METHOD FOR CHANGING A DIRECTION OF MOVEMENT OF AN ELEVATOR CAR OF AN ELEVATOR, AND THE ELEVATOR THEREOF

(71) Applicant: Kone Corporation, Helsinki (FI)

(72) Inventors: Tero HAKALA, Helsinki (FI); Tero PUROSTO, Helsinki (FI); Marko MINKKINEN, Helsinki (FI); Jouni LAPPALAINEN, Helsinki (FI)

(73) Assignee: Kone Corporation, Helsinki (FI)

(21) Appl. No.: 16/692,353

(22) Filed: Nov. 22, 2019

Related U.S. Application Data
(63) Continuation of application No. PCT/FI2018/050406, filed on May 30, 2018.

(30) Foreign Application Priority Data
Jun. 1, 2017 (EP) 17174025.1

(51) Int. Cl. B66B 9/00; B66B 11/04; B66B 1/30

(52) U.S. Cl. CPC B66B 9/003; B66B 1/308; B66B 11/0407

(57) ABSTRACT

An arrangement and a method for changing a direction of movement of an elevator car of an elevator, and the elevator thereof, are presented. The arrangement comprises at least two rotatable first stator beam parts for receiving at least two movers rotatably coupled to the elevator car and at least one actuator for rotating the at least two first stator beam parts. Said stator beam parts are arranged such that the axes of rotation of said stator beam parts align with the axes of rotation of the movers when the movers are arranged at corresponding positions. Each one of the movers rotates along with a respective first stator beam part when said respective first stator beam part is being rotated by the at least one actuator.

### CROSS-REFERENCE TO RELATED APPLICATION

This application is a continuation of PCT International Application No. PCT/FI2018/050406 which has an International filing date of May 30, 2018, and which claims priority to European patent application number 17174025.1 filed Jun. 1, 2017, the entire contents of both of which are incorporated herein by reference.

### TECHNICAL FIELD

The invention concerns in general the technical field of elevators. The invention concerns especially, however, not exclusively, to elevators utilizing electric linear motors and elevator car of which is configured to move in at least two directions, for example, vertical and horizontal.

### BACKGROUND

The elevator car of a conventional elevator is configured to be moved within the elevator shaft or hoist-way by means of a hoisting rope attached to the elevator car. The hoisting rope is furthermore in connection to a hoisting motor which may be arranged, for example, to the top part of the elevator shaft.

At the present time, the elevators utilizing electric linear motors are being developed. The movement of the elevator car is produced by the mover or movers in electromagnetic engagement with the stator of the electric linear motor. The stator is being arranged in fixed manner with respect to the environment, that is, the elevator shaft.

The use of electric linear motors in elevators facilitate designing elevators having elevator cars moving in addition to vertical directions, that is, up and down, also to horizontal directions and to any other direction as well, depending basically on the direction into which the stator of the electric linear motor has been arranged.

In conventional elevators having hoisting rope and elevator car configured to move only in vertical directions, there was no need to take into account the issue of changing the direction of the elevator car to any other direction. However, in elevators having electric linear motors and elevator cars configured to be moved in vertical and horizontal directions, there is a need to develop a device or arrangement for changing the direction of the elevator car, for example, from vertical direction to horizontal direction and vice versa.

### SUMMARY

An objective of the present invention is to provide an arrangement, an elevator and a method for changing a direction of movement of an elevator car of an elevator. Another objective of the present invention is that the arrangement, the elevator and the method facilitate the elevator car to be moved in multiple directions within the elevator shaft.

The objectives of the invention are reached by an arrangement, an elevator and a method as defined by the respective independent claims. Some embodiments of the present invention are defined in the dependent claims.

According to a first aspect of the present invention, an arrangement for changing a direction of movement of an elevator car of an elevator is provided. The elevator comprises an electric linear motor for moving the elevator car. The arrangement comprises at least two rotatable first stator beam parts arranged to an elevator shaft for receiving at least two movers rotatably coupled to the elevator car and at least one actuator for rotating the at least two first stator beam parts. The at least two rotatable first stator beam parts are arranged such that the axes of rotation of the first stator beam parts align with the axes of rotation of the movers when the movers are arranged at corresponding positions with respect to the at least two first stator beam parts for changing the direction of movement of the elevator car. Furthermore, each one of the movers rotates along with a respective rotatable first stator beam part when said respective rotatable first stator beam part is being rotated by the at least one actuator.

The arrangement may comprise at least two first auxiliary stator beam parts arranged between two rotatable first stator beam parts so that said first stator beam parts are configured to be aligned with the first auxiliary stator beam parts.

Ends of the first stator beam parts may be shaped, particularly rounded, for facilitating the rotation and aligning of the first stator beam parts with respect to at least each other and/or, optionally, counter-parts, such as other parts of the respective stator beam.

Each one of the rotatable first stator beam parts may be coupled to a respective actuator for rotating said rotatable first stator beam part coupled thereto.

The first stator beam parts may be configured to be rotated one at a time when the movers are arranged at the corresponding positions with respect to the at least two first stator beam parts for changing the direction of movement of the elevator car.

The stators may be made of ferromagnetic material.

According to a second aspect, an elevator comprising at least one arrangement according to the first aspect is provided. The elevator further comprises at least two stator beams extending along the elevator shaft, each of said beams comprising at least one stator, and at least two movers rotatably coupled to the elevator car. The movers are arranged to be in electromagnetic engagement with the stators of the stator beams and arranged to be moved along the at least two stator beams and the at least two rotatable first stator beam parts.

The elevator may comprise two stator beams and at least four rotatable first stator beam parts arranged to the elevator shaft for receiving at least four movers rotatably coupled to the elevator car and configured such that two of said at least four rotatable first stator beam parts align with respect to each other in positions prior to and after the change of the direction of movement.

Each of the stator beams may comprise four stators arranged so that there is one stator on one side of the stator beam.

Each one of the movers may comprise at least one unit of electromagnetic components for producing varying magnetic field for moving the mover along the respective stator beam.

The movers may be arranged to be C- or U-shaped comprise a corresponding number of units of electromagnetic components with respect to a number stators on the respective stator beam. Said units of electromagnetic components may, preferably, be arranged to face the stators for establishing the electromagnetic engagement between said units and said stators. The movers may at least partially enclose the corresponding stator beams.

The movers may be arranged to displace perpendicularly with respect to the direction of the axes of rotation of the movers in elastic manner, such as by a spring or an elastic element, for facilitating the changing of the direction of movement of an elevator car.

The stator beam parts may be implemented without any windings.

According to an embodiment, the at least two rotatable stator beam parts comprise no permanent magnets as well as no windings either.

The elevator may comprise at least two second stator beam parts comprised in the at least two stator beams, wherein the at least two second stator beam parts are being arranged to be horizontal, vertical, or in any direction other than horizontal or vertical.

The elevator may comprise at least two elevator cars configured to be moved along the at least two stator beams in the elevator shaft, wherein each one of the at least two elevator cars comprises at least two movers rotatably coupled to an elevator car and arranged to move along the respective stator beam.

According to a third aspect, a method for changing a direction of movement of an elevator car of an elevator is provided, wherein the elevator comprises an electric linear motor. The method comprises
receiving at least two movers by at least two first stator beam parts,
aligning the axes of rotation of the movers with the axes of rotation of the at least first stator beam parts in a first position prior to the change of the direction of movement, and
rotating the at least first stator beam parts from the first position to a second position by a number of actuators, wherein the at least two movers are being rotated simultaneously along with the rotation of the first stator beam parts by the first stator beam parts.

The present invention provides an arrangement, an elevator and a method for changing a direction of movement of an elevator car. The arrangement, the elevator and the method provide advantages over known solutions such that there may be several elevator cars running in the elevator shaft, and the elevator shaft may include parts having different directions with respect to each other. The omitting of hoisting ropes is beneficial especially in case of elevator shafts or elevator car pathways being especially long, for example, in very tall buildings, in which case the loading of the hoisting rope would easily become too high.

Various other advantages will become clear to a skilled person based on the following detailed description.

The expression “a plurality of” refers herein to any positive integer starting from two, e.g. to two, three, or four.

The expression “a number of” refers herein to any positive integer starting from one, e.g. to one, two, or three.

The terms “first”, “second” and “third” do not denote any order, quantity, or importance, but rather are used to distinguish one element from another.

The exemplary embodiments of the present invention presented herein are not to be interpreted to pose limitations to the applicability of the appended claims. The verb “to comprise” is used herein as an open limitation that does not exclude the existence of also un-recited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

The embodiments of the present invention are illustrated by way of example and not by way of limitation in the figures of the accompanying drawings.

FIGS. 1A and 1B illustrate schematically an elevator according to an embodiment of the present invention.

FIG. 2 illustrates schematically an elevator according to an embodiment of the present invention.

FIGS. 3A and 3B illustrate schematically arrangements according to two embodiments of the present invention.

FIGS. 4A-4E illustrate schematically arrangements according to various embodiments of the present invention.

FIGS. 5A-5C illustrate schematically electric linear motors, or at least parts thereof, according to some embodiments of the present invention.

FIGS. 6A and 6B illustrate schematically stator beam parts of an electric linear motor according to an embodiment of the present invention.

FIGS. 7A and 7B illustrate schematically stator beam parts of an electric linear motor according to an embodiment of the present invention.

FIG. 8 illustrates schematically an elevator control unit according to an embodiment of the present invention.

FIG. 9 illustrates a flow diagram of a method according to an embodiment of the present invention.

### DESCRIPTION OF SOME EMBODIMENTS

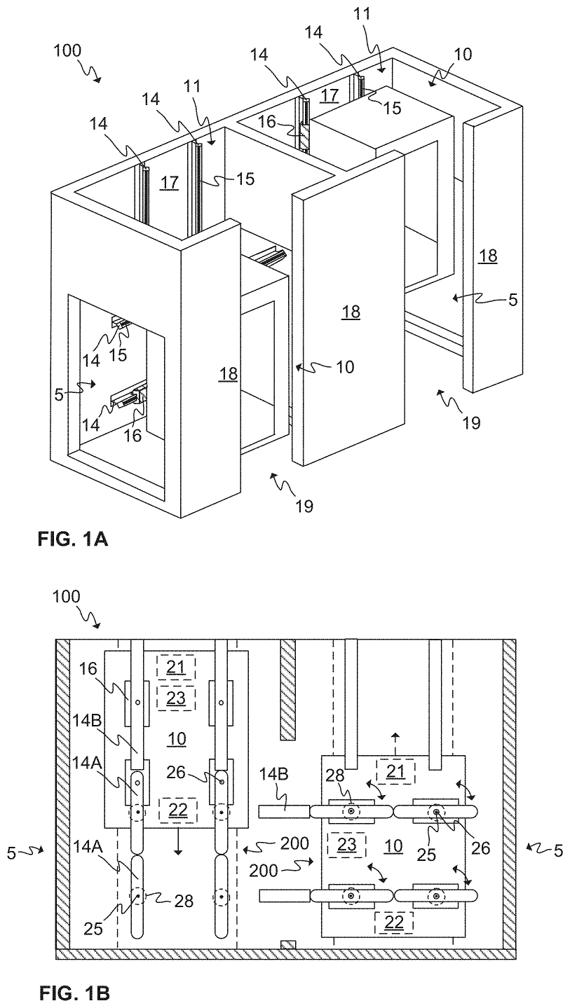

FIG. 1A illustrates schematically a part of an elevator 100 according to an embodiment of the present invention. There are two elevator cars 10 configured to be moved in the elevator shaft 11 by electric linear motor. The electric linear motor comprises a stator 15 or stators 15 comprised in a stator beam 14 or beams 14, in this case two. A stator beam 14 may be arranged vertically or horizontally, that is, in FIG. 1A, the elevator 100 comprises vertical stator beam 14 or beams 14 and/or horizontal stator beam 14 or beams 14. However, the stator beam 14 or beams 14 may also be arranged to any direction(s) in which the elevator car 10 is desired to be moved. One stator beam 14 may, preferably, be comprised of a plurality of stator beam parts arranged one after another to yield the desired length for the stator beam 14 in whole.

The electric linear motor further comprises a mover 16 or movers 16 arranged or coupled to the elevator car 10 or cars 10. The mover 16 or movers 16 are arranged to be in electromagnetic engagement with the stator 15 or stators 15 comprised in the stator beam 14 along which the mover 16 is configured to be moved, thus enabling the movement of the elevator car 10 with which the mover 16 has been mechanically coupled with.

In FIG. 1A, the stator beams 14 are arranged to the back wall 17 of the elevator shaft 11. It should be noted, however, that the elevator shaft 11 refers herein to the elevator car pathway which, as described above, may include vertical parts, horizontal parts, and/or parts having a third direction different with respect to vertical and horizontal directions. For example, the part of the elevator shaft 11 depicted in FIG. 1A essentially comprises two vertical parts and one horizontal part. In FIG. 1A, the elevator shaft 11 or the elevator car pathway 11 further comprises a front wall 18. The front wall 18 may, preferably, comprise an opening 19 for entering into the elevator car 10 or cars 10. Although shown in FIG. 1A that the opening 19 for entering the elevator cars 10 is arranged only at vertical parts of the elevator shaft 11, the opening 19 may as well be arranged to the horizontal part or any part of the elevator shaft 11. It should be noted, however, that the elevator shaft 10 may in some cases comprise only one wall or a structure arranged to accommodate the necessary equipment such as the stator beam 14. Thus, the elevator shaft 11 or the elevator car pathway 11 does not necessarily have to define a substantially closed volume, that is, surrounded by wall elements or glass or any other structures as long as there is at least a support structure to support the stator beam(s) 14.

FIG. 1A further illustrates that the movers 16 are configured to enable a change in their positions. As can be seen, the mover 16 arranged to the elevator car 10 on the left in FIG. 1A is in horizontal position. The mover 16 arranged to the elevator car 10 on the right in FIG. 1 is, on the other hand, in vertical position. To achieve this, the mover 16 or movers 16 of the elevator 100 are arranged to be rotatable. The movers 16 may thus always be arranged to align with the stator beam 14 along which the mover 16 is arranged to be moved.

The elevators 100, or particularly the elevator shaft 11 or shafts 11 thereof, according to the various embodiments of the present invention comprise at least one, however, preferably more than one, positions for changing the direction of movement of the elevator car 10, that is, movement direction changing positions 5, at which the direction of movement of an elevator car 10 may be changed from one direction to another, which said another is un-parallel relative to said one direction, for example, such as when changing the direction between the vertical and horizontal directions.

FIG. 1B illustrates schematically the part of the elevator 100 according to the embodiment in FIG. 1A by a sectional view from the back. In FIG. 1B, the elevator car 10 on the left corresponds to the elevator car 10 on the right in FIG. 1A, and vice versa. It can be seen in FIG. 1B that the stator beams 14 comprise a plurality of stator beam parts 14A, 14B. Some of the stator beam parts, that is, the second parts 14B, of the plurality of stator beam parts are, preferably, arranged in fixed manner in the elevator shaft 11, thus always having same position, preferably, aligned with the direction of the elevator shaft 11 at that particular position. However, some of the stator beam parts, that is, the first stator beam parts 14A, are rotatable or arranged to be rotated, for example, by an actuator 28, such as an electric motor. In general, the elevator 100 comprises at least first stator beam parts 14A, however, in various embodiments also second stator beam parts 14B.

At each movement direction changing position 5, there are at least two, preferably at least four, first stator beam parts 14A. These first stator beam parts 14A, for example, a total number of four, are comprised in an arrangement 200 for changing the direction of movement of the elevator car 10. There may, preferably, be one of said arrangement 200 at each one of the movement direction changing positions 5. Said arrangement 200 for changing the direction of movement of the elevator car 10 further comprises an actuator 28 or actuators 28, such as electric motor(s), for rotating one or several of the first stator beam parts 14A comprised in the arrangement 200. The actuator 28 may be driven or controlled or operated by a control unit (not shown) or an electrical drive (not shown) coupled to the actuator 28.

In FIG. 1B, the first stator beam parts 14A are configured to be rotated at least between the vertical and horizontal directions in order to align with the second stator beam parts 14B along which the elevator car 10 is then configured to be further moved. The change of the direction of movement of the elevator car 10 may be implemented, for example, so that the elevator car 10 is first moved or driven to the movement direction changing position 5 in such a way that a rotational axis 25 of the first stator beam part 14A aligns with a rotational axis 26 of the corresponding mover 16, as shown in FIG. 1B. Once the axes 25, 26 have been substantially aligned, the first stator beam part 14A begins to rotate, or being rotated by an actuator 28 such as an electric motor driven by an electrical drive, and thus also simultaneously rotates the corresponding rotatable mover 16. Once a new position has been reached, for example, after rotating the first stator beam part 14A and the mover 16 from the vertical direction to the horizontal direction, the elevator car 10 may be moved in the new direction of the stator beam 14, in this case in the horizontal direction.

In FIG. 1B, the elevator car 10 on the left is moving down and approaching a movement direction changing position 5. The first stator beam parts 14A of the movement direction changing position 5 in question are arranged already to vertical direction and thus ready to receive the elevator car 10 coming from above. The elevator car 10 on the right is, however, already at the other movement direction changing position 5 of FIG. 1B. The first stator beam parts 14A are currently still at the horizontal position. However, the first stator beam parts 14A, and thus also the movers 16, of the elevator car 10 may, and have to be, rotated to the vertical direction, such as shown with the two-headed arrows in FIG. 1B, before the elevator car 10 may be further moved upwards.

The elevator car(s) 10 may, preferably, comprise electrical drive 21 or drives 21 for operating the electrical equipment 23 of the elevator car 10. These may be, for example, lighting, user interfaces, control unit(s), mover(s) of the electric linear motor, emergency brakes, etc. The elevator car(s) 10 may also comprise an electrical energy storage 22, such as a battery 22 and, optionally, a capacitor such as a supercapacitor. The electrical energy storage 22 may be utilized to provide electrical power to electrical drive 21 or directly to the electrical equipment 23 comprised in the elevator car 10. The electrical energy storage 22 may be utilized simultaneously or periodically or depending on the position of the elevator car 10 in the elevator shaft 11 to draw energy from or to store energy into the electrical energy storage 22.

The mover 16 or movers 16 may be operated or controlled by the electrical drive 21 or drives 21 coupled to the elevator car 10. The electrical drive(s) 21 may be, for example, frequency converters or inverters configured to produce alternating current (AC) in order to produce desired current and a magnetic field for generating a force to move the mover 16 along the stator beam 14.

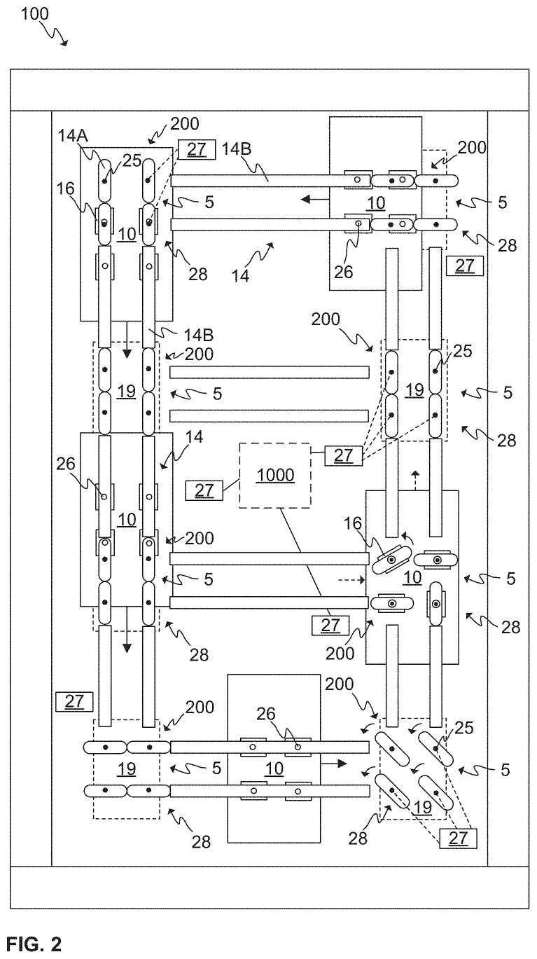

FIG. 2 illustrates schematically an elevator 100 according to an embodiment of the present invention. The elevator 100 comprises a plurality of elevator cars 10, that is, in this case, five. The opening(s) 19 for entering the elevator car(s) 10 has been shown with a rectangular having dashed lines representing landing floor doors or door openings 19. As can be seen, the movement direction changing positions 5 are arranged at landing floors, however, the movement direction changing positions 5 may as well be arranged at positions other than landing floors, for example, due to a shape of the elevator shaft 11 or elevator car pathway 11 which may have a turn due to the shape and structures of the target, such as a building, into which the elevator 100 has been installed or is to be installed. Furthermore, the landing floors may have been arranged at positions other than the movement direction changing positions 5. Although in FIG. 2 the movement direction changing positions 5 are arranged as pairs having the same position with respect to vertical direction, they may as well be arranged at different positions with respect vertical direction. The two columns of landing floors and movement direction changing positions 5 may be identical or may be different.

FIG. 2 further illustrates that each one of the first stator beam parts 14A comprised in one arrangement 200 for changing the direction of movement of the elevator car 10 may be rotated one at a time. This may be especially beneficial when the elevator car 10 is at the movement direction changing position 5. By changing the position of each one of the first stator beam parts 14A may cause vibrations or twitches or jerks to the elevator car 10 if the rotational axes 25, 26 are not perfectly aligned. By rotating only one first stator beam part 14A at a time, the vibrations or jerks of the elevator car 10 may be reduced. However, if there is no elevator car 10 at the movement direction changing position 5, all of the first stator beam parts 14A of the arrangement at said movement direction changing position 5 may be rotated simultaneously, thus preparing the movement direction changing position 5 more quickly for receiving the next elevator car 10.

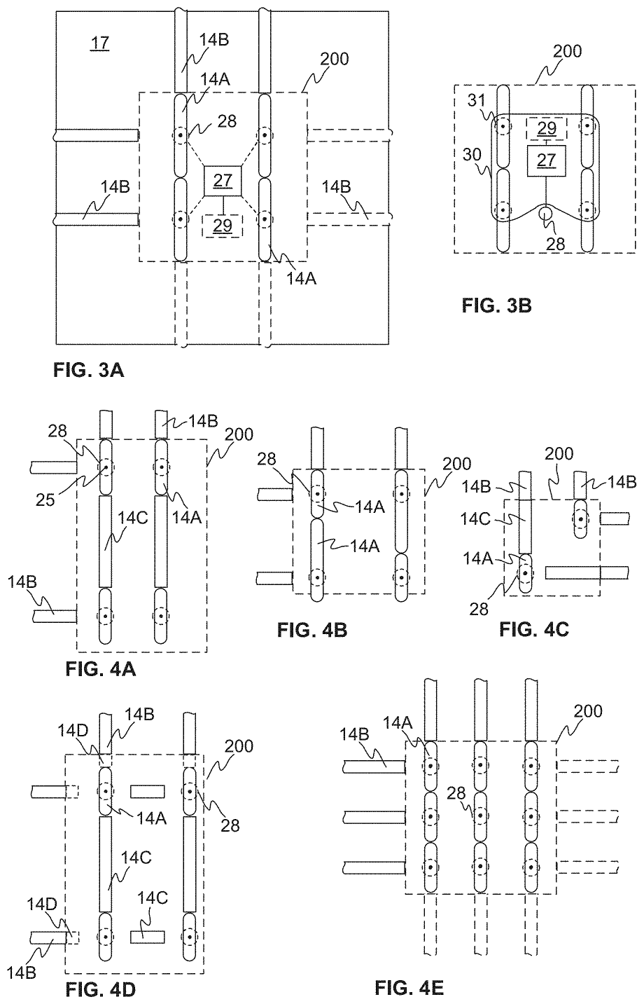

FIG. 3A illustrates schematically an arrangement 200 for changing the direction of movement of an elevator car 10 according to an embodiment of the present invention. The arrangement 200 may be arranged to the back wall 17 of the elevator shaft 11 or to any support structure for the stator beam 14 of the electric linear motor of the elevator 100. The arrangement comprises a plurality of first stator beam parts 14A, an actuator 28, for example, an electric motor, for changing the position of the first stator beam parts 14A, a control unit 27 for controlling the operation of the actuator 28. There may also be an electrical energy storage 29, such as a battery, comprised in the arrangement 200.

FIG. 3B illustrate an arrangement 200 for changing the direction of movement of an elevator car 10 according to another embodiment of the present invention which is identical to one illustrated in FIG. 3A notwithstanding the way of rotating the first stator beam parts 14A comprised in the arrangement 200. The arrangement 200 in FIG. 3B comprises an actuator 28, for example, an electric motor, for changing the changing the position of the first stator beam parts 14A. In this particular case, one actuator 28 is responsible for changing the position of each of the first stator beam parts 14A comprised in the arrangement 200. This may be implemented by power transmission means for mechanical power transmission 30, such as a belt, band, strap, chain, or the like. The first stator beam parts 14A may be configured to be rotatable by utilizing rotation means for producing rotatability 31, such as, a pivot, a bearing, or the like. According to the embodiment in FIG. 3B, all of the first stator beam parts 14A of the arrangement 200 always rotate simultaneously.

FIG. 4A illustrates an arrangement 200 for changing the direction of movement of an elevator car 10 according to an embodiment of the present invention. The arrangement 200 may comprise in addition to the first stator beam parts 14A, the control unit 27 (not shown in FIGS. 4A-4E for clarity reasons), and the actuator 28 two first auxiliary stator beam parts 14C, for instance. By utilizing first auxiliary stator beam parts 14C, first stator beam parts 14A may be identical, however, they do not have to be arranged in identical distances with respect to each other. In case of four identical first stator beam parts 14A, in order to rotate the parts 14A and to obtain continuous stator beam 14 for moving the elevator car 10, the first stator beam parts 14A must be arranged at certain, same distances from each other. This may further be clarified in case of FIG. 4A so that the distance from the rotational axis 25 of the top left first stator beam part 14A to the rotational axis 25 of the top right first stator beam part 14A is the same as the distance from the rotational axis 25 of the top left first stator beam part 14A to the rotational axis 25 of the bottom left first stator beam part 14A. This yields an arrangement 200 having the rotational axes 25 of the first stator beam parts 14A defining a square. However, utilization of first auxiliary stator beam parts 14C provides more freedom for arranging the first stator beam parts 14A of the arrangement 200.

FIG. 4B illustrates an arrangement 200 for changing the direction of movement of an elevator car 10 according to another embodiment of the present invention. As can be seen, the first stator beam parts 14A are not identical, but have different lengths. In this case too, however, the distances between the rotational axes are identical; however, they could in this case too be different if first auxiliary stator beam parts 14C would be utilized as in FIG. 4A.

FIG. 4C illustrates an arrangement 200 for changing the direction of movement of an elevator car 10 according to another embodiment of the present invention. The arrangement 200 according to this embodiment comprises two first stator beam parts 14A. The stator beam part 14A are essentially identical and in order to form continuous stator beam 14, there are two first auxiliary stator beam parts 14C utilized between a first stator beam part 14A and a second stator beam part 14B as shown in FIG. 4C. The first stator beam parts 14A may alternatively be designed so that the first stator beam part 14A on the left is long enough to yield a continuous stator beam 14 without utilizing first auxiliary stator beam parts 14C. In that case, the first stator beam part 14A on the left would be significantly longer than the one on the right, thus resulting in non-identical first stator beam parts 14A, however, by utilizing non-identical first stator beam parts 14A, it is possible to build an arrangement 200 from where the elevator car 10 may continue in all four directions, up, down, left and right. This is not possible in case of utilizing fixedly arranged first auxiliary stator beam parts 14C as shown in FIG. 4C.

FIG. 4D illustrates an arrangement 200 for changing the direction of movement of an elevator car 10 according to still another embodiment of the present invention. In this case, first auxiliary stator beam parts 14C having vertical and horizontal directions are utilized. By utilizing first auxiliary stator beam parts 14C provides still further freedom to arrange the first stator beam parts 14A appropriately. FIG. 4D further illustrates second auxiliary stator beam parts 14D of the arrangement 200. These special parts 14D may be adapted to better receive the rotating first stator beam part 14A or they may be utilized as adapters between different second 14B and first stator beam parts 14A. By utilizing second auxiliary stator beam parts 14D it becomes necessary to change only the second auxiliary stator beam parts 14D if the repetitive rotation of the first stator beam part 14A damages the counter-part, avoiding thus the need to change the whole second stator beam part 14B which may be, for example, of the order of some meters or even tens of meters in length.

FIG. 4E illustrates an arrangement 200 for changing the direction of movement of an elevator car 10 according to still another embodiment of the present invention. According to this embodiment, the elevator 100 comprises three parallel stator beams 14 instead of two as shown in FIGS. 1A-4D. The arrangement 200 thus comprises nine first stator beam parts 14A. In this case too first auxiliary stator beam parts 14C may be utilized to provide freedom for arranging the first stator beam parts 14A. According to an embodiment of the present invention, there are three stator beams 14 such as shown in FIG. 4E, however, there are only three first stator beam parts 14A arranged in similar manner as in FIG. 4C. In this case too, it is possible to utilize first auxiliary stator beam parts 14C or to utilize non-identical first stator beam parts 14A.

Although not shown in FIGS. 4A, 4B and 4D, the arrangements 200 depicted therein may be utilized for changing the direction of movement of the elevator car 10 in various other directions in addition to ones illustrated (up and left).

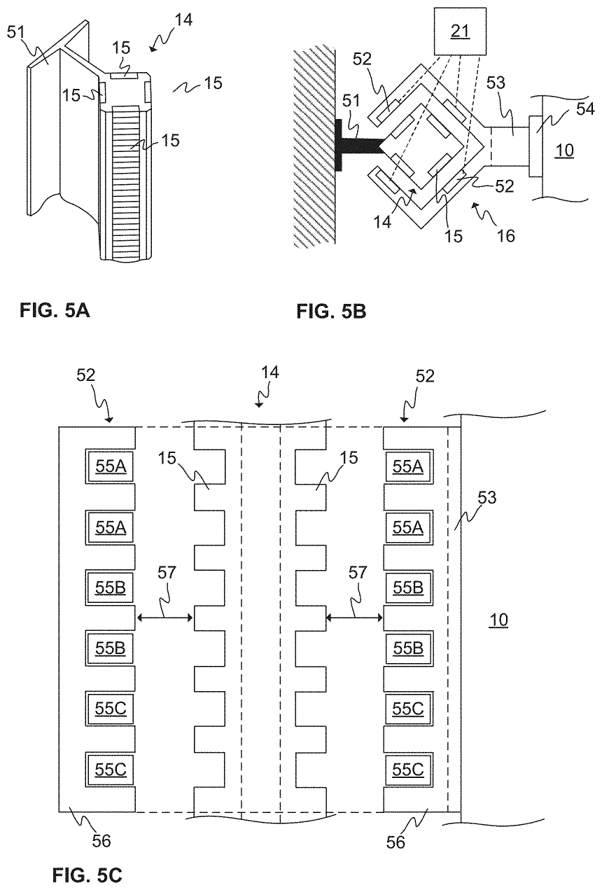

FIG. 5A illustrates schematically a part of the stator beam 14, or a stator beam part 14A, 14B, according to an embodiment of the present invention by a perspective view. The part of the stator beam 14 comprises at least one stator 15 extending substantially along the whole stator beam 14. There may, advantageously, be four stators 15 arranged at all four sides of the stator beam 14. There may also be a fastening portion 51 or portions 51 by which said part 14 may be attached in fixed manner to the structures, such as a wall, of the elevator shaft 11, or rotatably in case of a first stator beam part 14A. The fastening portion 51 may also be a separate fastening portion 51 which may then be attached to the stator beam 14 for arranging the stator beam 14 into the elevator shaft 11 or may be an integrated part of the stator beam 14 or a part thereof. The stators 15 may, preferably, be of ferromagnetic material and comprise teeth on their outer surface. According to a preferable embodiment of the present invention, the stator beam 14 or beams 14 are passive in the sense that they do not comprise controllable elements or components, such as coils, for controlling the movement of the mover 16 along the stator beam 14. The stator beam 14 or beams 14 may still, however, comprise such active elements as means for rotating a piece or a part of the stator beam 14 or locking means such as for locking the stator beam 14 into a position or, for example, elements utilized for aligning two parts of the stator beam 14 with respect to each other, such as, for example, the dowel 71 or the pin 71 in FIG. 7B.

FIG. 5B illustrates schematically an electric linear motor, or at least a part thereof, according to an embodiment of the present invention. The electric linear motor comprises a mover 16, preferably, a C-shaped or U-shaped (not shown) mover 16. The mover 16 comprises at least one unit of electromagnetic components 52 comprising at least one of coil and, optionally, preferably, permanent magnet(s) and/or magnetic core element(s) or ferromagnetic material. The unit or units of electromagnetic components 52 may, preferably, be comprised in the mover 16 and adapted to face the stator 15 or stators 15 of the stator beam 14, as shown in FIG. 5B, for instance. The units of electromagnetic components 52 are arranged to be in electromagnetic engagement with the stators 15 for moving the mover 16 along the stator beam 14. There may also be a support portion 53 by which the mover 16 may be attached in rotatable manner to the elevator car 10, for example, to the back wall 17 of the car 10. As can be seen, the mover 16 may be shaped and designed in such a way as to enable the movement of the mover 16 along the stator beam 14 without interference from the fastening or support portions 51, 53. There may, furthermore, be further support portions 54 utilized to attach the mover 16 to the elevator car 10.

The movement of the mover 16 along the stator beam 14 may be implemented by known control methods, such as, field-oriented or vector control or the like. The basic idea is to produce an alternating magnetic field, for example by an electrical drive 21, by injecting current to a unit of electromagnetic components 52 of the mover 16, such as to a winding or coil thereof. The unit of electromagnetic components 52 facing the stator 15 then co-acts with the stator 15 through the electromagnetic engagement and produces a force which moves the mover 16 and thus the elevator car 10 along the stator beam 14. FIG. 5C illustrates schematically an electric linear motor, or at least a part thereof, according to an embodiment of the present invention. The stator beam 14 comprises stators 15 on opposite sides of the stator beam 14. The stators 15 comprise stator teeth having a distance between two consecutive teeth. The mover 16 comprises units of electromagnetic components 52 arranged to face the stators 15 of the stator beam 14 and configured to establish an electromagnetic engagement, for example, over an air gap 57 to enable movement of the mover 16 with respect to the stator beam 14, between said units 52 and stators 15. The mover 16 comprises mover teeth around which the coils 55A-55C of the units of electromagnetic components 52 may be arranged around. In this case, each one of said units 52 comprises at least three coils 55A, 55B, 55C, and, optionally, preferably permanent magnets and/or ferromagnetic material 56 or mover irons 56. There may, alternatively, be more or fewer coils. The coils 55A-55C may be controlled, for example, so as to inject three-phase current having a phase shift of 120 degrees between two phases. The coils 55A-55C may be controlled, as stated hereinbefore, by an electrical drive 21 such as a frequency converter or an inverter. If an electrical energy storage 22, such as a battery, coupled to the elevator car 10 is being utilized, the electrical drive 21 may draw electrical power from the storage 22 to convert the direct current (DC) of the battery to suitable AC for the mover 16 to be moved along the stator beam 14.

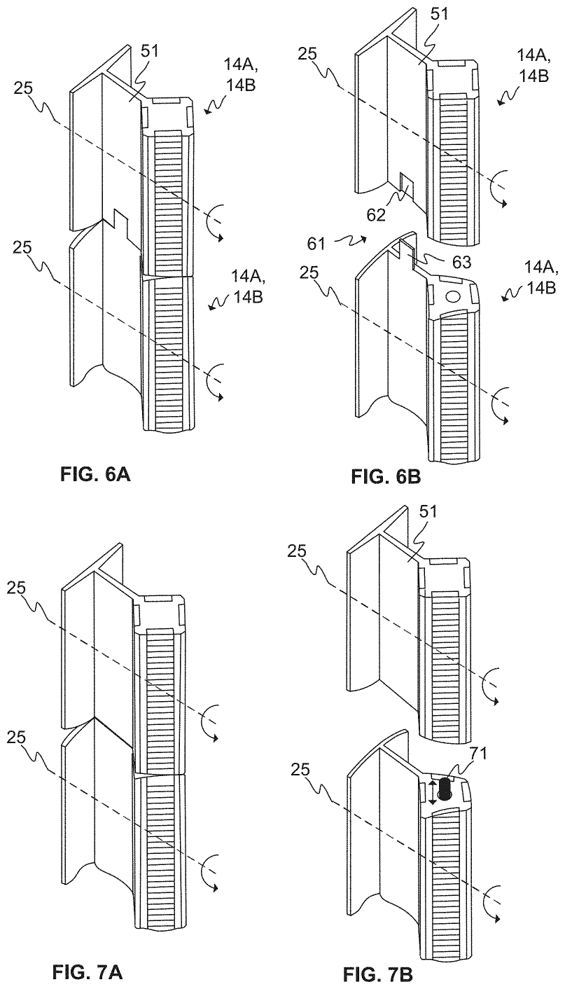

FIG. 6A illustrates schematically two stator beam parts according to an embodiment of the present invention. There may be two first stator beam parts 14A, or one first 14A and one second 14B stator beam part in FIG. 6A. At least one end of both of the stator beam parts may have been rounded in order to facilitate to rotating movement of said parts with respect to each other. Preferably, only the end or ends of the first stator beam parts 14A may be rounded, however, also other shapes may be utilized in the second stator beam parts 14B for facilitating the movement of the stator beam parts with respect to each other. In FIG. 6A, the stator beam parts are aligned and, thus, the mover 16 configured to be moved along the stator beam 14 over the seam between the two stator beam parts.

FIG. 6B illustrates schematically the rotation of the stator beam parts 14A shown in FIG. 6A. In this case, both of the parts are first stator beam parts 14A and may thus be rotated as shown by the arrows around the axes of rotation 25. The stator beam parts 14A may additionally comprise locking or aligning means 61, such as, comprising an alignment part 62, in this case protruding from the stator beam part below, and a counter-part 63, such as the recess 63 or indent 63 in FIG. 6B. It should be noted that the stator beam parts are illustrated as being at a distance greater than in FIG. 6A from each other in order to show the locking or aligning means 61 for locking and/or aligning the stator beam parts with respect to each other, that is, for illustrative purposes.

FIGS. 7A and 7B illustrate schematically two stator beam parts according to another embodiment of the present invention. In this case too, the distance between the two stator beam parts in FIG. 7B is shown to be greater than in 7A for illustrative purposes. In FIG. 7B, the locking or aligning means 61 comprises a dowel 71 or a pin 71 which may be moved or its position changed depending on the position of the stator beam part. For example, the dowel 71 may reside inside the stator beam part wherever the stator beam part is being rotated. The dowel 71 may then be pushed out from the stator beam part, for example, by utilizing a mechanism controlled by the control unit 27. There may, preferably, be a hole or recess or cavity arranged to the stator beam part above for receiving the dowel 71 or the pin 71 in order to align the stator beam parts and lock them to the corresponding position with respect to each other. The mechanism may comprise, for example, electromagnets and/or spring elements, or levers or actuators, such as electric motors or servos. The dowel 71 may also be pushed out hydraulically or pneumatically, and then pulled inside the stator beam part by a spring, for instance.

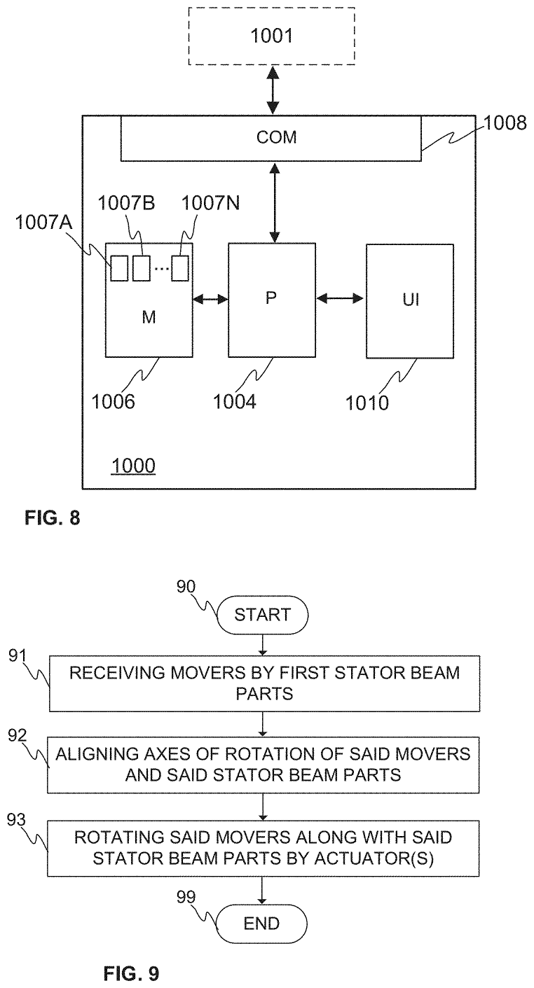

FIG. 8 illustrates schematically an elevator control unit 1000 according to an embodiment of the present invention. External units 1001, such as the control units 27 or other equipment of the elevator 100, may be connected to a communication interface 1008 of the elevator control unit 1000. External unit 1001 may comprise wireless connection or a connection by a wired manner. The communication interface 1008 provides interface for communication with external units 1001 such as the control units 27, elevator car 10, the electric linear motor, or the mover 16 thereof, the doors of the landing floors 19, and/or the electrical drive(s) 21. There may also be connection to an external system, such as a laptop or a handheld device. Alternatively or in addition, there may also be a connection to a database of the elevator 100 or an external database including information used in controlling the operation of the elevator 100.

The elevator control unit 1000 may comprise one or more processors 1004, one or more memories 1006 being volatile or non-volatile for storing portions of computer program code 1007A-1007N and any data values and possibly one or more user interface units 1010. The mentioned elements may be communicatively coupled to each other with e.g. an internal bus.

The processor 1004 may be arranged to access the memory 1006 and retrieve and store any information therefrom and thereto. For sake of clarity, the processor 1004 herein refers to any unit suitable for processing information and control the operation of the elevator control unit 1000, among other tasks. The operations may also be implemented with a microcontroller solution with embedded software. Similarly, the memory 1006 is not limited to a certain type of memory only, but any memory type suitable for storing the described pieces of information may be applied in the context of the present invention.

FIG. 9 illustrates a flow diagram of a method according to an embodiment of the present invention.

At 90, referring to a start-up phase, the necessary tasks such as obtaining components and systems, and calibration and other configuration may take place. Specific care must be taken that the individual elements and material selections work together. Communication and electrical connections between various components and (sub-)systems may be established.

At 91, receiving the movers 16 by the first stator beam parts takes place. This may, preferably, occur by moving the movers 16 by the electric linear motor along the stator beam 14, either along another first 14A or a second 14B stator beam part towards said first stator beam parts 14A.

At 92, aligning the axes of rotation 26 of the movers 16 with the axes of rotation 25 of the first stator beam parts 14A in a first position takes place. This may, preferably, also be implemented by controlling the electric linear motor so as to move the movers 16 at positions in which said axes 25, 26 align with respect to each other. The “aligning” refers herein to the situation where said axes, which are parallel relative to each other, are at the corresponding positions with respect to each other, that is, for example, as shown in FIG. 1B for the movers 16 coupled to the elevator car 10 on the right in the figure.

At 93, rotating the first stator beam parts from the first position to a second position by a number of actuators, wherein the movers are being rotated simultaneously along with the rotation of the first stator beam parts takes place.

At 99, the method execution is ended or stopped. The method flow may be executed at least once every time the elevator car 10 is at a movement direction changing position 5. The method may be executed, for example, twice in case of an override of the control of the movement of an elevator car in case of an emergency.

The specific examples provided in the description given above should not be construed as limiting the applicability and/or the interpretation of the appended claims. Lists and groups of examples provided in the description given above are not exhaustive unless otherwise explicitly stated.

1. An arrangement for changing a direction of movement of an elevator car of an elevator, which the elevator comprises an electric linear motor for moving the elevator car,
wherein the arrangement comprises
at least two rotatable first stator beam parts comprising stators without a winding and arranged to an elevator shaft for receiving at least two movers, each one of the movers comprising electromagnetic components, such as a winding or a coil, arranged to be in electromagnetic engagement with the stator of the respective first stator beam part for moving the mover along the respective first stator beam part and being rotatably coupled to the elevator car, and
at least one actuator for rotating the at least two first stator beam parts,
wherein the at least two rotatable first stator beam parts are arranged such that the axes of rotation of the first stator beam parts align with the axes of rotation of the movers when the movers are arranged at corresponding positions with respect to the at least two first stator beam parts for changing the direction of movement of the elevator car, wherein each one of the movers rotates along with a respective rotatable first stator beam part when said respective rotatable first stator beam part is being rotated by the at least one actuator.

2. The arrangement according to claim 1, comprising at least two first auxiliary stator beam parts arranged between two rotatable first stator beam parts so that said first stator beam parts are configured to be aligned with the first auxiliary stator beam parts.

3. The arrangement according to claim 1, wherein ends of the first stator beam parts are shaped, particularly rounded, for facilitating the rotation and aligning of the first stator beam parts with respect to at least each other (and/or counter-parts).

4. The arrangement according to claim 1, wherein each one of the rotatable first stator beam parts is coupled to a respective actuator for rotating said rotatable first stator beam part coupled thereto.

5. The arrangement according to claim 1, wherein the first stator beam parts are configured to be rotated one at a time when the movers are arranged at the corresponding positions with respect to the at least two first stator beam parts for changing the direction of movement of the elevator car.

6. The arrangement according to claim 1, wherein the stators are made of ferromagnetic material.

7. An elevator, wherein the elevator comprises at least one arrangement according to claim 1, at least two stator beams extending along the elevator shaft, each of said beams comprising at least one stator, and the at least two movers rotatably coupled to the elevator car, wherein the movers are arranged to be in electromagnetic engagement with the stators of the stator beams and arranged to be moved along the at least two stator beams and the at least two rotatable first stator beam parts.

8. The elevator according to claim 7, comprising two stator beams and at least four rotatable first stator beam parts arranged to the elevator shaft for receiving at least four movers rotatably coupled to the elevator car and configured such that two of said at least four rotatable first stator beam parts align with respect to each other in positions prior to and after the change of the direction of movement.

9. The elevator according to claim 7, wherein each of the stator beams comprises four stators arranged so that there is one stator on one side of the stator beam.

10. The elevator according to claim 7, wherein each one of the movers comprises at least one unit of electromagnetic components for producing varying magnetic field for moving the mover along the respective stator beam.

11. The elevator according to claim 7, wherein the movers are arranged to be C- or U-shaped, and each mover comprises a corresponding number of units of electromagnetic components with respect to a number stators on the respective stator beam, and the units of electromagnetic components are arranged to face the stators for establishing the electromagnetic engagement between said units and said stators.

12. The elevator according to claim 7, wherein the movers are arranged to displace perpendicularly with respect to the direction of the axes of rotation of the movers in elastic manner, such as by a spring or an elastic element, for facilitating the changing of the direction of movement of an elevator car.

13. The elevator according to claim 7, comprising at least two second stator beam parts comprised in the at least two stator beams, the at least two second stator beam parts being arranged to be horizontal, vertical, or in any direction other than horizontal or vertical.

14. The elevator according to claim 7, comprising at least two elevator cars configured to be moved along the at least two stator beams in the elevator shaft, wherein each one of the at least two elevator cars comprises at least two movers rotatably coupled to an elevator car and arranged to move along the respective stator beam.

15. A method for changing a direction of movement of an elevator car of an elevator, wherein the elevator comprises an electric linear motor, wherein the method comprises:
receiving at least two movers, each one of the movers comprising electromagnetic components, such as winding or a coil, by at least two first stator beam parts comprising stators without a winding, wherein each one of the movers is arranged to be in electromagnetic engagement with the stator of the respective first stator beam part for moving the mover along the respective first stator beam part,
aligning the axes of rotation of the movers with the axes of rotation of the at least first stator beam parts in a first position prior to the change of the direction of movement, and
rotating the at least first stator beam parts from the first position to a second position by a number of actuators, wherein the at least two movers are being rotated simultaneously along with the rotation of the first stator beam parts.
